(19) United States
(12) Patent Application Publication
(10) Pub. No.: US 2006/0248446 A1
(43) Pub. Date: Nov. 2, 2006

(54) Method for displaying and navigating through data

(76) Inventors: David P. Carlson, Shoreview, MN (US); Larry Constantine, Rowley, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/119,186

(22) Filed: Apr. 29, 2005

(51) Int. Cl. G06F 15/00

(52) U.S. Cl. 715/513

(57) ABSTRACT

A method of displaying information is comprised of displaying a representation associated with certain information and displaying, proximate to the representation, an alphanumeric code assigned thereto. The code is comprised of one or more keystrokes needed to select the information associated with the representation. The information may be hierarchically arranged such that a plurality of representations is at the same level in the hierarchical arrangement. In that case, displaying a code may include displaying a code comprised of a common letter/number and a unique number/letter, respectively, proximate to the plurality of representations. Another aspect of the present disclosure is directed to a method of organizing information for a display wherein the information is represented in the display by a plurality of indicium. A code comprised of the input needed to select the information associated with its indicium is assigned. The assigned code is displayed proximate to the indicium representative of the information to which the code is associated. Other aspects of the present disclosure include computer readable media carrying instructions for carrying out or enabling the disclosed methods as well as computers and computer systems for carrying out or enabling the disclosed methods. Because of the rules governing abstracts, this abstract should not be used in construing the claims.

### BACKGROUND OF THE INVENTION

The present disclosure is directed generally to graphical user interfaces (GUIs) and, more particularly, to a method and apparatus for displaying and navigating through data sets or other information in an easy and intuitive manner.

Existing techniques for keyboard shortcuts fall into two categories. So-called “shortcuts” combine one or more “shift” keys (Shift, Alt, Ctrl on Windows-style keyboards) with a single keyboard character (e.g., Ctrl+C for “copy to clipboard”). Such shortcuts have two principle disadvantages: First, they are invisible to users and so must be committed to memory. Additionally, they are limited in number, principally because so many, such as, Ctrl+C, have reserved meanings assigned by the operating system or standard software.

So-called “accelerators” (sometimes referred to as “access keys”) employ underlined characters within menu or item names or other text labels on the user interface combined with the Alt (“Alternate”) key. Although such characters are visible to users, the standard scheme has two important limitations. Accelerator keys displayed on the user interface are fixed and must be chosen in advance by the designer to avoid conflicts or ambiguities, which is not always easy to do. Second, because only a single character can be referenced at each level, the number of alternatives is limited, particularly for numbers which are restricted to a single character.

U.S. Pat. No. 6,876,397 entitled “Menu Display Apparatus” discloses a menu display apparatus including a selection unit for inputting data for selecting an arbitrary one of a plurality of menu items respectively assigned with numbers which are displayed on a screen of a display unit, and a display control unit for displaying on the screen the number corresponding to the menu item selected by the selection unit.

U.S. Pat. No. 6,880,131 entitled “Apparatus and Method for Selecting Data Sets” discloses a storage medium for storing a large number of data sets or files as grouped in a smaller number of data groups or directories, each data group containing a plurality of data sets. On a control panel is provided a display screen, and a plurality of group call buttons to be individually allocated for the respective data groups and a plurality of data set designating buttons to be individually allocated for the respective data sets. When the user actuates an intended one of the group call buttons, identifying names or marks of the data sets of the called group are listed in a display screen for a further selection of the intended data set from among the listed group by user's actuation of an intended one of the data set designating buttons. This enables an easy and speedy selection of a particular intended data set from among a large number of data sets.

None of the various types of interfaces, however, is directed to enabling users to navigate (move about, switch) flexibly and efficiently among a complex and open-ended collection of functions, data structures and alternative views presented on a GUI entirely through simple keyboard shortcuts or through combinations of keyboard and pointer operations. Such an interface is desirable because it does not require the user to memorize or remember keyboard shortcut strings. Additionally, such an interface is desirable because it is not limited by the number of single keystroke combinations (such as Alt+A) available on the keyboard. Further, such an interface provides a visually consistent and easily interpreted structure within which to present complex structures of functions and views. Also, the set of functions or views potentially available to the user can be very large and the set immediately available can be dynamically expanded and contracted at will by the user.

Accordingly, a need exists for a human machine interface (“HMI”) scheme that offers each of the advantages identified above.

### SUMMARY

This disclosure uses a control key, e.g. the Alt key, in combination with an alphanumeric code which may be a single letter/number to select a level of navigation or collection of data, followed by a number/letter or sequence which specifies a unique item, e.g a tab, function, view, shortcut, record, or data element, etc., within the selected level.

One aspect of the present disclosure is directed to a method of displaying information comprising displaying a representation associated with certain information and displaying, proximate to the representation, an alphanumeric code assigned thereto. The code is comprised of the input, e.g., one or more keystrokes, needed to select the information associated with the representation. The information may be hierarchically arranged such that a plurality of representations is at the same level in the hierarchical arrangement. In that case, displaying a code may include displaying a code comprised of a common letter/number and a unique number/letter, respectively, proximate to the plurality of representations.

Another aspect of the present disclosure is directed to a method of navigating through a plurality of information each represented in a display by an indicium. Each indicium having associated therewith a code comprised of the input needed to select the information represented by its indicium. The method is comprised of depressing a control key on a keyboard and keying in, or otherwise inputting, the code associated with the indicium representative of the information to be viewed. The control key may be one of the Alt, Shift, or Ctrl key, among others.

Another aspect of the present disclosure is directed to a method of organizing information for a display wherein the information is represented in the display by an indicium. A code comprised of one or more keystrokes needed to select the information associated with its indicium is assigned. The assigned code is displayed proximate to the indicium representative of the information set to which the code is associated.

Other aspects of the present disclosure include computer readable media carrying instructions for carrying out or enabling the disclosed methods as well as computers and computer systems for carrying out or enabling the disclosed methods.

### BRIEF DESCRIPTION OF THE DRAWINGS

For the present disclosure to be easily understood and readily practiced, the present disclosure will now be described, for purposes of illustration and not limitation, in conjunction with the following figures, wherein:

FIG. 1 illustrates a screen shot showing information displayed using an HMI scheme according to one embodiment.

FIG. 2 illustrates another screen shot showing one less navigation level than the screen shot of FIG. 1.

FIG. 3 is a simplified diagram of a processing system on which the interface scheme shown in FIGS. 1 and 2 may reside according to one embodiment.

FIG. 4 is a simplified diagram of a computer system incorporating the processing system of FIG. 3 according to one embodiment.

### DETAILED DESCRIPTION OF THE INVENTION

This disclosure is an HMI scheme that enables users to navigate (move about, switch) flexibly and efficiently among a complex and open-ended collection of functions, data structures, and alternative views presented on a graphical user interface entirely through simple keyboard shortcuts or through combinations of keyboard and pointer operations.

The display scheme utilizes visual placeholders (called navigation pads), that serve as reminders to users by making visible to the user the otherwise hidden keystrokes needed to a select particular view, function, data, among others. The navigation pads may be used to display an extensible set of alphanumeric keyboard shortcuts for any number of views, functions, data, among others. In one embodiment, these features are integrated with a multilevel presentation and navigation scheme based on the widely used “tabbed notebook” style of presentation combined with other presentation schemes or styles, including presentation of data in arrays of records or items. The tab scheme is dynamically changeable to enable users to expand or contract the number of views, functions, data, etc. visible and immediately available at will.

Advantages of the scheme are that it does not require the user to memorize or remember keyboard shortcut strings. The scheme is not limited by the number of single keystroke combinations (such as Alt+A) available on the keyboard. Also, the scheme provides a visually consistent and easily interpreted structure within which to present complex structures of functions and views. Furthermore, the set of functions or views potentially available to the user can be very large and the set immediately available can be dynamically expanded and contracted at will by the user.

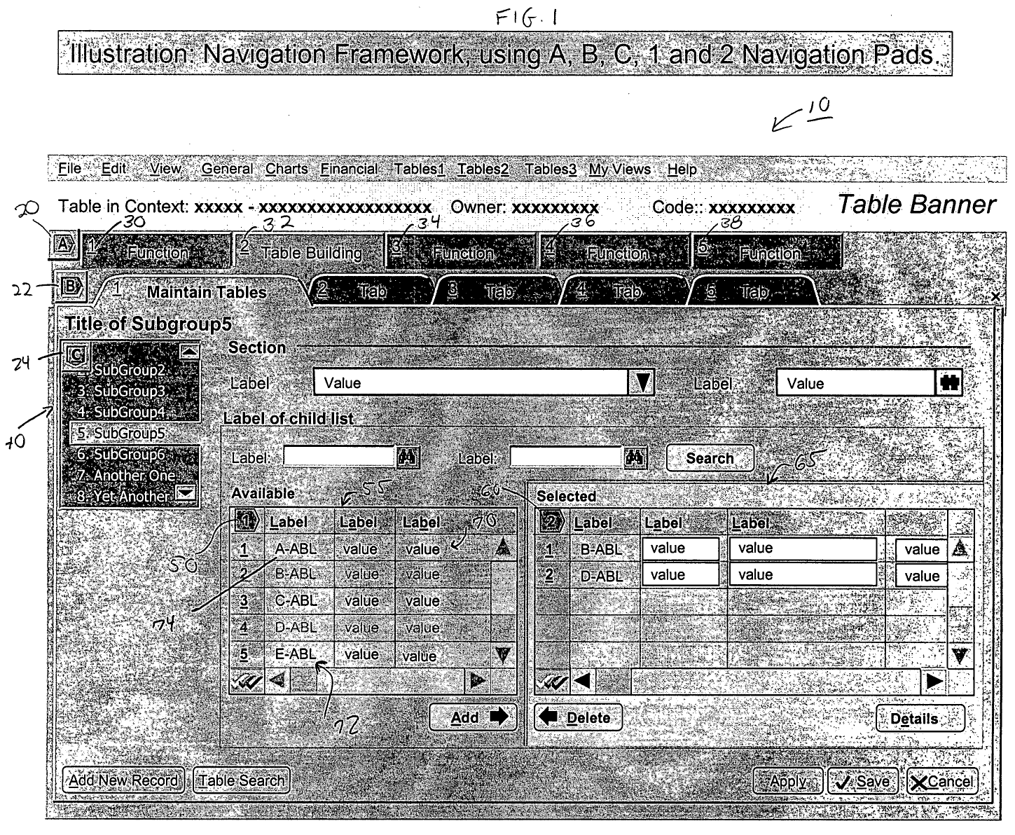

FIG. 1 illustrates a screen shot 10 showing information displayed for a system using an HMI scheme according to one embodiment. The screen shot 10 illustrated in FIG. 1 includes visual placeholders, called navigation pads, that are visible to the user to allow the user to select particular views, data, etc. In the current embodiment, these navigation pads are shown as single “designator” characters, e.g. the letter A 20, the letter B 22 and the letter C 24. Each of the letter designator characters 20, 22, 24 is displayed proximate to a representation, icon, indicium or the like which is associated with some information, which may be a view, function, data set, among others. In the illustrated embodiment, the navigation pads 20 and 22 are shown as displayed proximate to separate rows, while the navigation pad 24 is shown proximate to a drop box having subgroups which may be selected. Certain of the navigation pads in FIG. 1, pads 30, 32, 34, 36 and 38, for example, carry “sequence numbers”. The sequence numbers are unique within their row, but need not be unique within the display.

The “designator” character navigation pads 20, 22, 24 may be a letter or a number that determines which level of navigation or collection of data or data group is being referenced by the user. The “sequence numbers” navigation pads 30, 32, 34, 36, 38 may be single digit or multi digit numbers, that can be any number of digits, that specify a unique tab, function, view, shortcut, record, data element of data set, among others. In accordance with one embodiment of the present disclosure, the user utilizes the Alt key (although some other control key, e.g. Ctrl, Shift, etc., may be used if it is available) in combination with the character(s) from one of the “designator” character navigation pads 20, 22, 24 followed by the single or multi-digit character(s) from one of the “sequence number” navigation pads 30, 32, 34, 36, 38 to select and display the desired information, view, function, etc.

For example, to access information located in the Table Building folder as shown in FIG. 1, the user would depress the Alt key, followed by the “A” key (which is shown as “designator” character navigation pad 20), followed by the “2” key (which is shown as “sequence number” navigation pad 32). This scheme provides the user with visual prompts, i.e. navigation pads, to allow the user to easily and intuitively select a particular view, data group, data set, etc. through simple keyboard shortcuts. It should be apparent to one skilled in the art that alternative “shortcut” mechanisms may be utilized while remaining within the scope of the present invention. For example, a pointer operation, such as a mouse may be used to “click” on the desired navigation pad, or a combination of keystrokes and pointer operations may be used while remaining within the scope of the present invention.

In the current embodiment each “designator” character navigation pad, for example “A”, shown as navigation pad 20, is associated with a particular data group of information. Included within that particular data group of information are a plurality of data sets. Each of the plurality of data sets are associated with a particular “sequence number” navigation pad. For example, as previously discussed and as shown in FIG. 1, the information contained under the Tab entitled “Table Building” is associated with navigation pad “2” and shown in FIG. 1 as navigation pad 32. The present invention provides a mechanism that allows for an extensible set of alphanumeric keyboard (or other input device) shortcuts for any number of functions, views or collections of data. Therefore, the user can expand or contract the number of collections of views immediately available at will. In the current embodiment, the information is displayed in a hierarchical and/or nested manner.

In the current embodiment, the particular data group or data set of information associated with a particular navigation pad is associated with that navigation pad's particular letter or number. As discussed above, this enhances the user's ability to easily and efficiently locate and track information. This also allows the user to easily navigate from one set of information, data group or data set to another.

Further, in the current embodiment multiple forms may be grouped via use of the content navigator or C-level navigation, 40 as shown in FIG. 1. This “C” level of navigation behaves as previously discussed with the “A” and “B” levels of navigation, but the tabs are arranged vertically instead of horizontally. Otherwise, the functionality remains the same.

In FIG. 1, navigation pads 50 and 60 are associated with record lists 55 and 65, respectively. In the prior art, to move around within the lists requires tabbing left, right, up, or down, until you reach the cell of interest. Using the scheme of the present invention, a row, column, or cell can be uniquely identified by visual prompts on the screen. For example, row 70 can be selected by depressing the alt key followed by 1 (to select record list 55) and 1 (to select row 70). Column 72 can be selected by depressing the alt key followed by 1 (to select record list 55) and L (to select column 72). Cell 74 can be selected in one of two ways; depressing the alt key followed by the sequence 1 (to select record list 55), 1 (to select row 70) and L (to select column 72), or depressing the alt key followed by the sequence 1 (to select the record list 55), L (to select the column 72) and 1 (to select row 70). Because the row 70 and the column 72 intersect at cell 74, that is the cell that is selected.

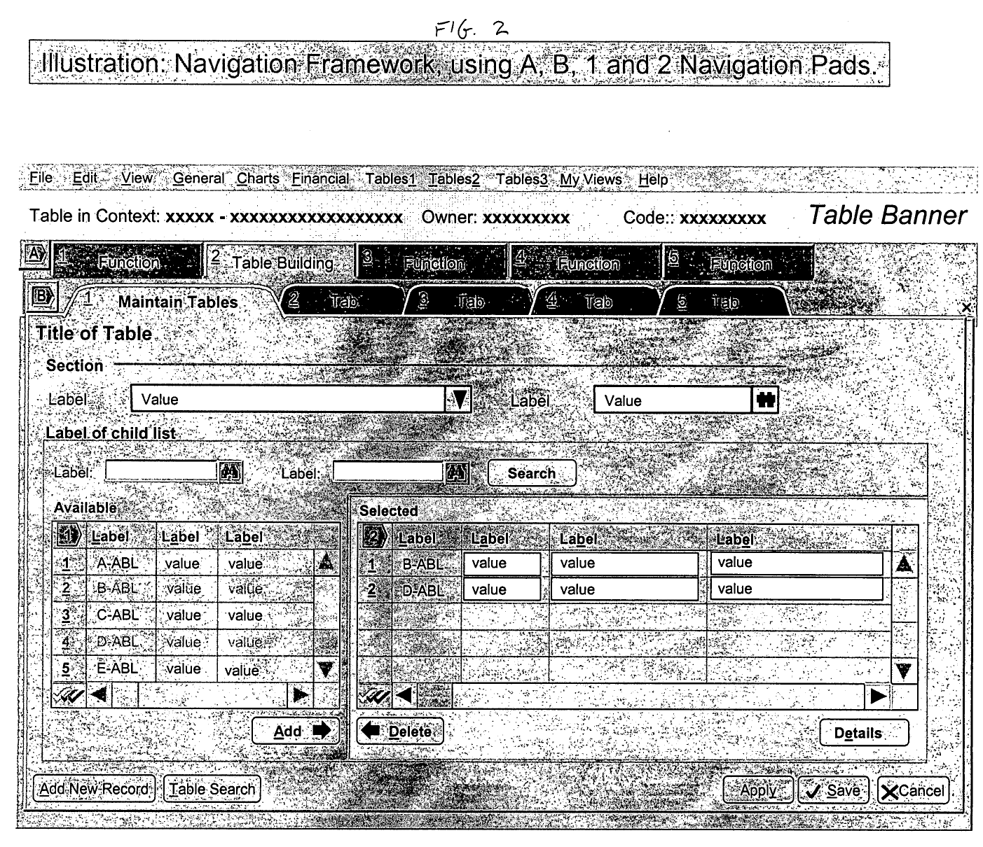

FIG. 2 is substantially the same view as FIG. 1 but without the “C” level displayed. The reader should understand that the various navigation pads can be applied without dependence upon the presence of other navigations pads, and that embodiments such as use of a “C” level navigation pad without presence of either an “A” or “B” level navigation are also possible.

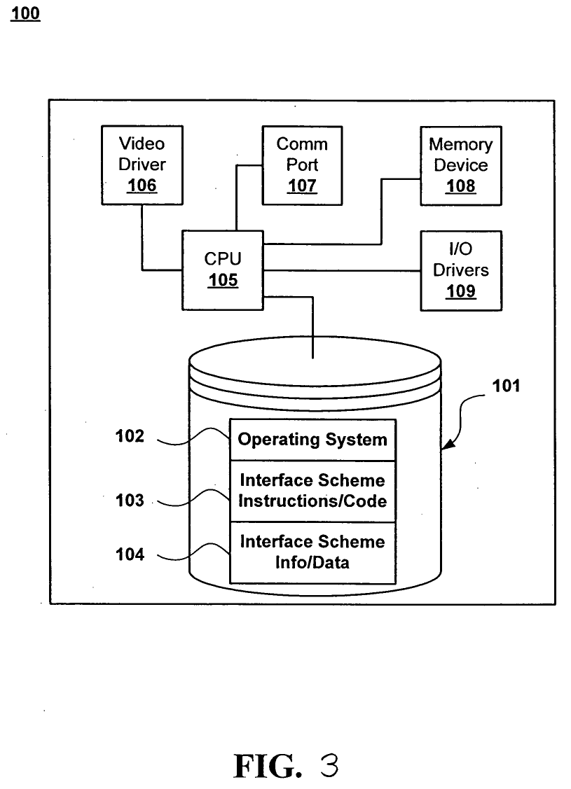

FIG. 3 is a simplified diagram of a processing system 100 on which the interface scheme may reside according to the current embodiment. The processing system 100 may include a central processing unit (CPU) 105 in communication with a data storage device 101, a video driver 106, a communications port 107, a memory device 108, and an input/output driver 109, among others. The CPU 105 may be a microprocessor, micro-controller, and ASIC, among others. The CPU 105 is capable of performing various computing functions, such as executing software functions to perform specific calculations and/or data processing tasks. In the current embodiment, the CPU 105 is operable to implement the multi-level interface scheme as discussed above in conjunction with FIGS. 1 and 2.

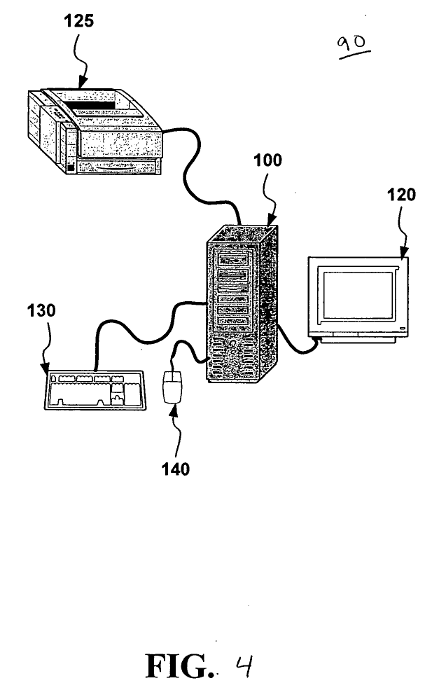

The data storage device 101 may be a CD-ROM, disk drive, tape drive, ZIP drive, etc. which is operable to store various software and data sets for use by processing system 100. In the current embodiment, the data storage device may be used to store an operating system 102 (e.g. Windows®, etc.), the instructions/code for the interface scheme 103, and a database containing data/information 104, among others. The memory device 108 may be a dynamic random access module (DRAM), flash memory, static memory, read-only memory (ROM) device, etc. that may be used, for example, to temporarily store instructions and data that are frequently accessed by the CPU 105. Video driver 106 is operable to drive a monitor (e.g. 120 as illustrated in FIG. 4), communications port 107 provides an interface between the processing system 100 and one or more communication devices (not shown), and I/O driver 109 is an interface between various input devices (e.g., keyboard, mouse, microphone, bar code reader, RFID reader, touch screen, etc) and output devices (e.g., printers, speakers, etc.)

FIG. 4 is a simplified diagram of a computer system 90 incorporating the processing system 100 of FIG. 3 according to one embodiment. The computing system 90 includes a keyboard 130 and mouse 140 connected to the processing system 100 (e.g., via I/O driver 109) to allow a user to manually input data, instructions, etc., to operate the processing system 100. The computing system also includes a monitor 120 and printer 125 connected to the processing system 100 (e.g., via video driver 106 and I/O driver 109, respectively) to display or otherwise output data generated by the processing system 100. Computing system 90 may also include mixed input/output devices (not shown) such as modems, network interface cards, and touch screens (among others) which may be connected to the processing system 100 (e.g. via communication port 107).

While the present disclosure has been described in connection with preferred embodiments thereof, those of ordinary skill in the art will recognize that many modifications and variations are possible. The present invention is intended to be limited only by the following claims and not by the foregoing description which is intended to set forth the presently preferred embodiment.

What is claimed is:

1. A method of displaying information, comprising:
displaying a representation associated with certain information; and
displaying, proximate to said representation, an alphanumeric code assigned to said certain information, wherein said code is comprised of the input needed to select said certain information associated with said representation.

2. The method of claim 1 wherein said information is hierarchically arranged such that a plurality of representations is at the same level in the hierarchical arrangement, and wherein said displaying a code includes displaying a code comprised of a common letter and a unique number proximate to said plurality of representations.

3. The method of claim 1 wherein said information is hierarchically arranged such that a plurality of representations is at the same level in the hierarchical arrangement, and wherein said displaying a code includes displaying a code comprised of a common number and a unique letter proximate to said plurality of representations.

4. The method of claim 1 wherein said representation includes an icon, and wherein said displaying a code includes displaying in a navigation pad positioned adjacent to said icon said alphanumeric code.

5. The method of claim 1 additionally comprising depressing a control key on a keyboard and inputting the alphanumeric code.

6. The method of claim 5 wherein said control key includes one of the Alt, Shift, or Ctrl key.

7. A method of navigating through a plurality of information represented in a display by a plurality of indicium, each indicium having associated therewith a code comprised of the input needed to select the information represented by its indicium, said method comprising:
depressing a control key on a keyboard and inputting the code associated with the indicium representative of the information to be viewed.

8. The method of claim 7 wherein said control key includes the Alt, Shift, or Ctrl key.

9. The method of claim 7 wherein said indicia are arranged in a plurality of rows, and wherein said codes include one of a unique letter or number for each row and one of a unique number or letter, respectively, for each indicium in said row.

10. The method of claim 7 wherein said indicia are arranged in a plurality of columns, and wherein said codes include one of a unique letter or number for each column and one of a unique number or letter, respectively, for each indicium in said column.

11. A method of organizing information for a display wherein the information is represented in the display by a plurality of indicium, the improvement comprising assigning a code comprised of the input needed to select the information associated with its indicium, said code to be displayed proximate to the indicium representative of the information to which the code is associated.

12. A computer readable medium carrying instructions which, when executed, perform a method, comprising:
displaying a representation associated with certain information; and
displaying, proximate to said representation, an alphanumeric code assigned to said certain information, wherein said code is comprised of the input needed to select said certain information associated with said representation.

13. The computer readable medium of claim 12 wherein said information is hierarchically arranged such that a plurality of representations is at the same level in the hierarchical arrangement, and wherein said displaying a code includes displaying a code comprised of a common letter and a unique number proximate to said plurality of representations.

14. The computer readable medium of claim 12 wherein said information is hierarchically arranged such that a plurality of representations is at the same level in the hierarchical arrangement, and wherein said displaying includes displaying a code comprised of a common number and a unique letter proximate to said plurality of representations.

15. The computer readable medium of claim 12 wherein said representation includes an icon, and wherein said displaying a code includes displaying in a navigation pad positioned adjacent to said icon said alphanumeric code.

16. The computer readable medium of claim 12 wherein said method additionally comprises receiving information that a control key has been depressed and an alphanumeric code input.

17. A computer readable medium carrying instructions which, when executed, enable a method of navigating through a plurality of information represented in a display by a plurality of indicium, each indicium having associated therewith a code comprised of the input needed to select the information represented by its indicium, said method comprising:
receiving information that a control key has been depressed and an alphanumeric code input; and
retrieving and displaying the information associated with said received alphanumeric code.

18. The computer readable medium of claim 17 wherein said indicia are arranged in a plurality of rows, and wherein said codes include one of a unique letter or number for each row and one of a unique number or letter, respectively, for each indicium in said row.

19. The computer readable medium of claim 17 wherein said indicia are arranged in a plurality of columns, and wherein said codes include one of a unique letter or number for each column and one of a unique number or letter, respectively, for each indicium in said column.
